(19) United States
(12) Patent Application Publication
(10) Pub. No.: US 2024/0116310 A1
(43) Pub. Date: Apr. 11, 2024

(54) Trochoid, Polar or Conic Section Spoke for Wheels

(71) Applicants: Blaine Forrest Weisman, Roslyn Heights, NY (US); Sydney Skye Weisman, Roslyn Heights, NY (US)

(72) Inventors: Blaine Forrest Weisman, Roslyn Heights, NY (US); Sydney Skye Weisman, Roslyn Heights, NY (US)

(21) Appl. No.: 18/045,453

(22) Filed: Oct. 10, 2022

(51) Int. Cl. B60B 9/26

(52) U.S. Cl. CPC B60B 9/26; B60B 2360/3416; B60B 2900/112; B60B 2900/113; B60B 2900/551

(57) ABSTRACT

The invention is for a single spoke for an entire wheel that connects the hub to the rim in the shape of a trochoid graph, polar graph, or series of connected conic sections. It is impossible to determine where the spoke begins or terminates as it's one continuous piece of material.

### REFERENCE TO RELATED PATENTS

### References Cited in the File of this Patent

U.S. Pat. No. 644,968A *1899-06-261900-03-06 Holman Crawford Wheel.
U.S. Pat. No. 703,029A *1901-12-311902-06-24 Frank A Wilkes Bicycle repair-spoke.
U.S. Pat. No. 4,729,605A *1984-06-181988-03-08 Mitsubishi Rayon Co., Ltd. Multiplex spoke for wheel
WO1991013771A21990-03-161991-09-19 Johnson Harold M High modulus multifilament spokes and method
U.S. Pat. No. 5,104,199A1990-10-261992-04-14 Raphael Schlanger Vehicle wheel
U.S. Pat. No. 5,350,221A *1991-07-111994-09-27 Edo Sports Inc. Fiber reinforced spoke for wheels of bicycles, wheelchairs and the like, and method of making same
U.S. Pat. No. 5,779,323A *1997-04-251998-07-14 Giant Manufacturing Co., Ltd. Spoked wheel with aerodynamic and rigidity imparting spokes
FR2761300A11997-03-281998-10-02 Campagnolo Srl Bicycle wheel-spoke design
U.S. Pat. No. 5,915,796A1997-04-291999-06-29 Dymanic Composites Inc. Composite fiber spoke vehicular wheel and method of making the same
WO2000035683A11998-12-142000-06-22 Raphael Schlanger Vehicle wheel
EP1044827A11999-04-162000-10-18 Mavic S. A. Spoke made of composite material for a wheel, and bicycle wheel with such spokes
EP1231077A22001-02-132002-08-14 Campagnolo S. R. L. Method for producing a bicycle wheel rim, apparatus for implementing the method and bicycle wheel rim obtained thereby
EP1304238A12001-10-192003-04-23 B.C. &amp; Sons Trading Ltd. Composite spoke, particularly for wheels of cycles, motorcycles, and the like
U.S. Pat. No. 6,783,192B2 *2000-09-152004-08-31 Campagnolo S. R. L. Wheel hub for bicycle

### United States Patents

U.S. Pat. No. 1,255,927 Putnam Feb. 12, 1918
U.S. Pat. No. 1,266,155 Putnam May 14, 1918
U.S. Pat. No. 1,586,425 Goodyear May 25, 1926
U.S. Pat. No. 1,788,174 Stanley Jan. 6, 1931
U.S. Pat. No. 1,907,762 Eksergian May 9, 1933
U.S. Pat. No. 2,046,216 Steward Jun. 30, 1936
U.S. Pat. No. 2,148,658 Stiiier Feb. 28, 1939
U.S. Pat. No. 2,548,929 Ash Apr. 17, 1951
U.S. Pat. No. 2,653,057 Sherman Sep. 22, 1953
U.S. Pat. No. 2,911,255 Bellairs Nov. 3, 1959
FOREIGN PATENTS 788,467 France Jul. 29, 1935 693,042
Great Britain Jun. 8, 1948 OTHER REFERENCES German printed application 1,081,330, May 5, 1960.
U.S. Pat. No. 5,975,645A
U.S. Pat. No. 5,975,645A Sargent Nov. 2, 1999

### BACKGROUND OF THE INVENTION

The spoked wheel dates to ancient Egypt 2000 B.C.E. This spoked wheel was a major improvement on the solid wheel and the log used previously. The spoked wheel allowed chariots to travel much faster than the solid wheel. This multi-spoked model, where each spoke directly connects the hub to the rim, has been the standard. If one looks at wheels today, they can all fall into two categories; spokes that are variations and/or improvements on the Egyptian design or the disk which is a variation and/or improvement on the solid wheel design dating to the beginning of civilization. The Trochoid, Polar or Conic Section Spoke would fall into neither of the two categories as it's a completely different design. Many of the improvements to the spoke, for which patents were issued were for materials and manufacture processes, not for drastic modifications to the design of the spoke itself.

### SUMMARY OF THE INVENTION

The Trochoid, Polar or Conic Section Spoke for Wheels is an invention for a single spoke for an entire wheel that connects the hub to the rim in the shape of a trochoid graph, polar graph, or series of connected conic sections. It is impossible to determine where the spoke begins or terminates as it's one continuous piece of material. The improved performance from using these continuously curved shapes is that a single spoke could absorb energy better than many spokes because in the many spoke design only a few of the spokes absorb the energy from a bump or pothole. This creates a situation where part of the wheel bares the energy and most of the wheel bares none. The Trochoid, Polar or Conic Section Spoke for Wheels distributes the energy throughout the wheel because the spoke is in one piece. All the shapes included in this application meet both the hub and the rim in the shape of an arch. It is a generally accepted physics principle that arch support is stronger than a linear support. Therefor a wheel made with a spoke in these shapes would be naturally stronger when manufactured in any material. A wheel made with this spoke can be made with any of the current manufacturing processes. This spoke also creates opportunities for more efficient manufacturing processes. The formulas included in this patent create infinite choices for the user. Since there are infinite external factors which include number of tires, type of material, gauge of material, quality of material, number of wheels, sizes of the wheels, weight of the vehicle, speed ratings, and g-force rating the user must test many different combinations of factors to see which combination best meets their need. The choices include which shape, size of loop, if any, number of petals, thickness of materials, tying overlaps or not, which material, whether to cast or use another manufacturing process. Because of all these open-ended factors, these choices are demonstrated and left open ended.

### FIELD OF THE INVENTION

### B60B Vehicle Wheels

Wheels (wheels for roller skates A63C 17/22; making wheels or wheel parts B21D 53/26; by rolling B21H 1/00; by forging, hammering, or pressing B21K 1/28) 1/00 Spoked wheels; Spokes thereof (non-metallic B60B 5/00 {; spoked wheels comprising rail-engaging elements B60B 17/001; making wheel spokes B21F 39/00})

1/0223 . . . {the dominant aspect being the spoke arrangement pattern}

1/0269 . . . {the spoke being curved or deformed over substantial part of length}

### BRIEF DESCRIPTION OF DRAWINGS

The purpose of many of these figures are to show hypotrochoids and epitrochoid spokes fit into 15-17″ car rims or in bicycle wheels with larger diameters. With these formulas the hypotrochoid and epitrochoid spokes have an infinite number of sizes and petals, both of which can be adjusted based on application. The thickness and choice of material used to create the spoke will also depend on the application of the spoke. Attaching the spoke to the hub or the rim will be dependent on the hub or rim to which its being applied and can be adjusted as needed.

A full and enabling disclosure of the present invention, including the best mode thereof, directed to one of ordinary skill in the art, is set forth in the specification, which makes reference to the appended figures, in which: These and other systems, methods, objects, features, and advantages of the present disclosure will be apparent to those skilled in the art from the following detailed description of the other embodiment and the drawings. All documents mentioned herein are hereby incorporated in their entirety by reference.

The foregoing features and elements may be combined in various combinations without exclusivity, unless expressly indicated otherwise. These features and elements as well as the operation thereof will become more apparent considering the following description and the accompanying drawings. It should be understood, however, the following description and drawings are intended to be exemplary in nature and non-limiting.

FIGS. 1-5 Hypotrochoid—5 Petal Spoke

Formula:

$$x ( t ) = ( 8 - 4.8 ) cos t + 5.7 cos \frac{8 - 4.8}{4.8} t \\ y ( t ) = ( 8 - 4.8 ) sin t - 3 sin \frac{8 - 4.8}{4.8} t$$

FIG. 1 5 Petal Hypotrochoid Spoke—Front view

Label #1—Rim
2—Hub
3—Lugs
4—5 Petal Hypotrochoid Spoke

FIG. 2 5 Petal Hypotrochoid Spoke 1^{st} 2 across—Front view
Displaying how the material would be laid if the spoke were not made by casting.

Label #5—5 Petal Hypotrochoid Spoke 2 across

FIG. 3 5 Petal Hypotrochoid Spoke 1^{st} 4 across—Front view
Displaying how the material would be laid if the spoke were not made by casting.

Label #6—5 Petal Hypotrochoid Spoke 4 across

FIG. 4 5 Petal Hypotrochoid Spoke—Offset 3D View

FIGS. 5-9 Hypotrochoid—9 Petal Spoke

Formula:

$$x ( t ) = ( 13.5 - 9.5 ) cos t + 3.5 cos \frac{13.5 - 9.5}{9.5} t \\ y ( t ) = ( 13.5 - 9.5 ) sin t - 3.5 sin \frac{13.5 - 9.5}{9.5} t$$

FIG. 5 9 Petal Hypotrochoid Spoke—Front view

Label #7—9 Petal Hypotrochoid Spoke

FIG. 6 9 Petal Hypotrochoid Spoke 1^{st} 2 across—Front view

Displaying how the material would be laid if the spoke were not made by casting.

Label #8—9 Petal Hypotrochoid Spoke 1^{st} 2 across

FIG. 7 9 Petal Hypotrochoid Spoke 1^{st} 4 across—Front view

Displaying how the material would be laid if the spoke were not made by casting.

Label #9—9 Petal Hypotrochoid Spoke 1^{st} 4 across

FIG. 8 9 Petal Hypotrochoid Spoke 1^{st} 6 across—Front view

Displaying how the material would be laid if the spoke were not made by casting.

Label #10—9 Petal Hypotrochoid Spoke 1^{st} 6 across

FIG. 9 9 Petal Hypotrochoid Spoke Offset 3D View

FIGS. 10-13 6 Petal Epitrochoid Spoke

Formula:

$$x ( t ) = ( 3 + 2.5 ) cos t - 3 cos \frac{3 + 2.5}{2.5} t \\ y ( t ) = ( 3 + 2 ) sin t - 3 sin \frac{3 + 2.5}{2.5} t$$

FIG. 10 6 Petal Epitrochoid Spoke—Front view

Label #11—6 Petal Epitrochoid Spoke

FIG. 11 6 Petal Epitrochoid Spoke 1^{st} 1% loops—Front view. Displaying how the material would be laid if the spoke were not made by casting.

Label #12—6 Petal Epitrochoid Spoke 1^{st} 1% loops

FIG. 12 6 Petal Epitrochoid Spoke 1^{st} 2% loops—Front view. Displaying how the material would be laid if the spoke were not made by casting.

Label #13—6 Petal Epitrochoid Spoke 1^{st} 2% loops

FIG. 13 6 Petal Epitrochoid Spoke 1^{st} 3% loops—Front view. Displaying how the material would be laid if the spoke were not made by casting.

Label #14—6 Petal Epitrochoid Spoke 1^{st} 3% loops

FIGS. 14-17 7 Petal Epitrochoid Spoke

Formula:

$$x ( t ) = ( 3.5 + 2 ) cos t - 3 cos \frac{3.5 + 2}{2} t \\ y ( t ) = ( 3.5 + 2 ) sin t - 3 sin \frac{3.5 + 2}{2} t$$

FIG. 14 7 Petal Epitrochoid Spoke—Front view

Label #15—7 Petal Epitrochoid Spoke

FIG. 15 7 Petal Epitrochoid Spoke 1^{st} 1% loops—Front view. Displaying how the material would be laid if the spoke were not made by casting.

Label #16—7 Petal Epitrochoid Spoke 1^{st} 1½ loops

FIG. 16 7 Petal Epitrochoid Spoke 1^{st} 2% loops—Front view. Displaying how the material would be laid if the spoke were not made by casting.

Label #17—7 Petal Epitrochoid Spoke 1^{st} 2% loops

FIG. 17 7 Petal Epitrochoid Spoke 1^{st} 3% loops—Front view. Displaying how the material would be laid if the spoke were not made by casting.

Label #18—7 Petal Epitrochoid Spoke 1^{st} 3% loops

FIGS. 18-21 8 Petal Epitrochoid Spoke

Formula:

$$x ( t ) = ( 4 + 1.5 ) cos t - 3 cos \frac{4 + 1.5}{1.5} t \\ y ( t ) = ( 4 + 1.5 ) sin t - 3 sin \frac{4 + 1.5}{1.5} t$$

FIG. 18 8 Petal Epitrochoid Spoke—Front view

Label #19—8 Petal Epitrochoid Spoke

FIG. 19 8 Petal Epitrochoid Spoke 1^{st} 1% loops—Front view. Displaying how the material would be laid if the spoke were not made by casting.

Label #20—8 Petal Epitrochoid Spoke 1^{st} 1% loops

FIG. 20 8 Petal Epitrochoid Spoke 1^{st} 2% loops—Front view. Displaying how the material would be laid if the spoke were not made by casting.

Label #21—8 Petal Epitrochoid Spoke 1^{st} 2% loops

FIG. 21 8 Petal Epitrochoid Spoke 1^{st} 3% loops—Front view. Displaying how the material would be laid if the spoke were not made by casting.

Label #22—8 Petal Epitrochoid Spoke 1^{st} 3% loops

FIGS. 22-25 8 Petal Orbital Epitrochoid Spoke

Formula:

x(t)=5.5 cos t+3 cos 9t

y(t)=5.5 sin t+3 sin 9t

FIG. 22 8 Petal Orbital Epitrochoid Spoke—Front view

Label #23—8 Petal Orbital Epitrochoid Spoke

FIG. 23 8 Petal Orbital Epitrochoid Spoke 1^{st} loop—Front view. Displaying how the material would be laid if the spoke were not made by casting.

Label #24—8 Petal Orbital Epitrochoid Spoke 1^{st} loop

FIG. 24 8 Petal Orbital Epitrochoid Spoke 1^{st} 2 loops—Front view. Displaying how the material would be laid if the spoke were not made by casting.

Label #25—8 Petal Orbital Epitrochoid Spoke 1^{st} 2 loops

FIG. 25 8 Petal Orbital Epitrochoid Spoke 1^{st} 3 loops—Front view. Displaying how the material would be laid if the spoke were not made by casting.

Label #26—8 Petal Orbital Epitrochoid Spoke 1^{st} 3 loops

FIGS. 26-29 10 Petal Big Loop Epitrochoid Spoke

Formula:

$$x ( t ) = ( 10 + 3 ) cos t - 5.5 cos \frac{10 + 3}{3} t \\ y ( t ) = ( 10 + 3 ) sin t - 5.5 sin \frac{10 + 3}{3} t$$

FIG. 26 10 Petal Big Loop Epitrochoid Spoke—Front view

Label #27—10 Petal Big Loop Epitrochoid Spoke

FIG. 27 10 Petal Big Loop Epitrochoid Spoke In 1% loops—Front view. Displaying how the material would be laid if the spoke were not made by casting.

Label #28—10 Petal Big Loop Epitrochoid Spoke 1^{st} 1% loops

FIG. 28 10 Petal Big Loop Epitrochoid Spoke 1^{st} 2% loops—Front view. Displaying how the material would be laid if the spoke were not made by casting.

Label #29—10 Petal Big Loop Epitrochoid Spoke 1^{st} 2% loops

FIG. 29 10 Petal Big Loop Epitrochoid Spoke 1^{st} 3% loops—Front view. Displaying how the material would be laid if the spoke were not made by casting.

Label #30—10 Petal Big Loop Epitrochoid Spoke 1^{st} 3% loops

FIGS. 30-33 12 Petal Polar Bicycle Wheel Spoke

Formula:

r=10 cos(6θ)

FIG. 30 12 Petal Polar Bicycle Wheel Spoke—Front view

Label #31—12 Petal Polar Bicycle Wheel Spoke

FIG. 31 12 Petal Polar Bicycle Wheel Spoke 1^{st} 2 across—Front view. Displaying how the material would be laid if the spoke were not made by casting.

Label #32—12 Petal Polar Bicycle Wheel Spoke 1^{st} 2 across

FIG. 32 12 Petal Polar Bicycle Wheel Spoke 1^{st} 4 across—Front view. Displaying how the material would be laid if the spoke were not made by casting.

Label #33—12 Petal Polar Bicycle Wheel Spoke 1^{st} 4 across

FIG. 33 12 Petal Polar Bicycle Wheel Spoke 1^{st} 6 across—Front view. Displaying how the material would be laid if the spoke were not made by casting.

Label #34—12 Petal Polar Bicycle Wheel Spoke 1^{st} 6 across

FIGS. 34-37 39 Petal Epitrochoid Spoke

Formula:

$$x ( t ) = ( 3.9 + 1.6 ) cos t - 3.2 cos \frac{3.9 + 1.6}{1.6} t \\ y ( t ) = ( 3.9 + 1.6 ) sin t - 3.2 sin \frac{3.9 + 1.6}{1.6} t$$

FIG. 34 39 Petal Epitrochoid Spoke—Front view

Label #35—39 Petal Epitrochoid Spoke

FIG. 35 39 Petal Epitrochoid Spoke 1^{st} 1% loops—Front view. Displaying how the material would be laid if the spoke were not made by casting.

Label #36—39 Petal Epitrochoid Spoke 1^{st} 1% loops

FIG. 36 39 Petal Epitrochoid Spoke 1^{st} 2% loops—Front view. Displaying how the material would be laid if the spoke were not made by casting.

Label #37—39 Petal Epitrochoid Spoke 1^{st} 2% loops

FIG. 37 39 Petal Epitrochoid Spoke 1^{st} 3% loops—Front view. Displaying how the material would be laid if the spoke were not made by casting.

Label #38—39 Petal Epitrochoid Spoke 1^{st} 3% loops

FIGS. 38-41 40 Petal Hypotrochoid Spoke

Formula:

$$x ( t ) = ( 8 - 4.6 ) cos t + 6 cos \frac{8 - 4.6}{4.6} t \\ y ( t ) = ( 8 - 4.6 ) sin t - 6 sin \frac{8 - 4.6}{4.6} t$$

FIG. 38 40 Petal Hypotrochoid Spoke—Front view

Label #39—40 Petal Hypotrochoid Spoke

FIG. 39 40 Petal Hypotrochoid Spoke 1^{st} 2 across—Front view. Displaying how the material would be laid if the spoke were not made by casting.

Label #40—40 Petal Hypotrochoid Spoke 1^{st} 2 across

FIG. 40 40 Petal Hypotrochoid Spoke 1^{st} 4 across—Front view. Displaying how the material would be laid if the spoke were not made by casting.

Label #41—40 Petal Hypotrochoid Spoke 1^{st} 4 across

FIG. 41 40 Petal Hypotrochoid Spoke 1^{st} 6 across—Front view. Displaying how the material would be laid if the spoke were not made by casting.

Label #42—40 Petal Hypotrochoid Spoke 1^{st} 6 across

FIGS. 42-45 1000 Loop Epitrochoid Spoke

Formula:

$$x ( t ) = ( - \text{.8} - 6.3 ) cos t - 3 cos \frac{8 - 4.6}{6.3} t \\ y ( t ) = ( - \text{.8} - 6.3 ) sin t - 6 sin \frac{- \text{.8} - 6.3}{6.3} t$$

FIG. 42 1000 Loop Epitrochoid—Front view

Label #43—1000 Loop Epitrochoid Spoke

FIG. 43 1000 Loop Epitrochoid Spoke 1^{st} Loop across—Front view. Displaying how the material would be laid if the spoke were not made by casting.

Label #44—1000 Loop Epitrochoid Spoke 1^{st} Loop across

FIG. 44 1000 Loop Epitrochoid Spoke 1^{st} Loop across—Front view. Displaying how the material would be laid if the spoke were not made by casting.

Label #45—1000 Loop Epitrochoid Spoke 1^{st} Loop across

FIG. 45 1000 Loop Epitrochoid Spoke 1^{st} Loop across—Front view. Displaying how the material would be laid if the spoke were not made by casting.

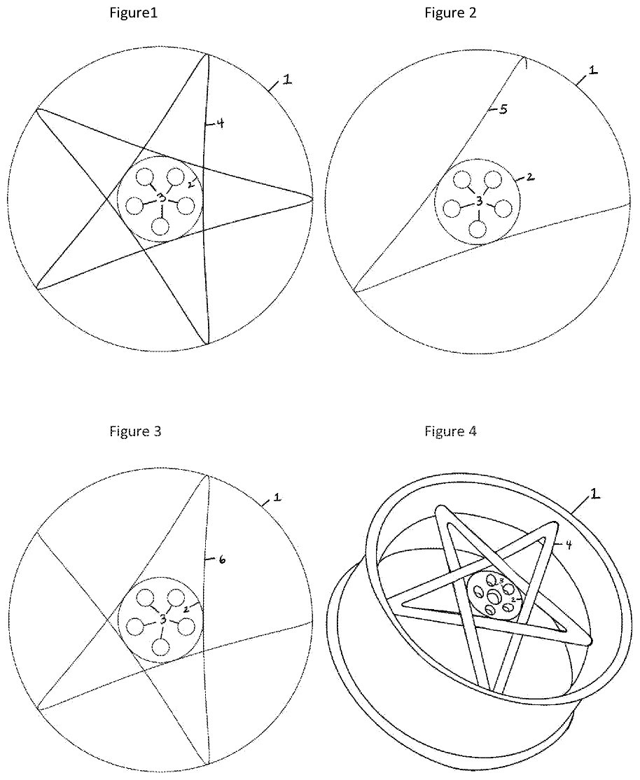

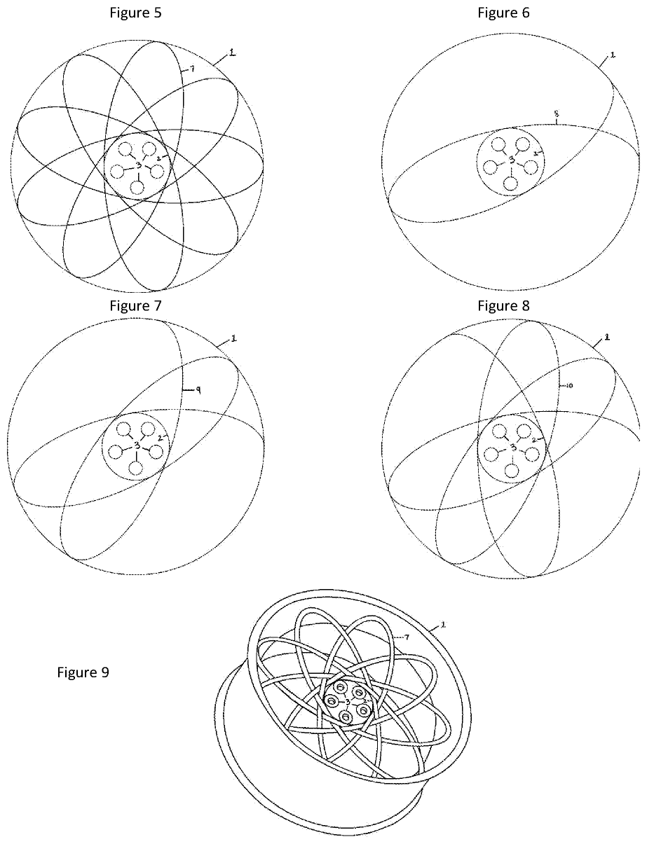

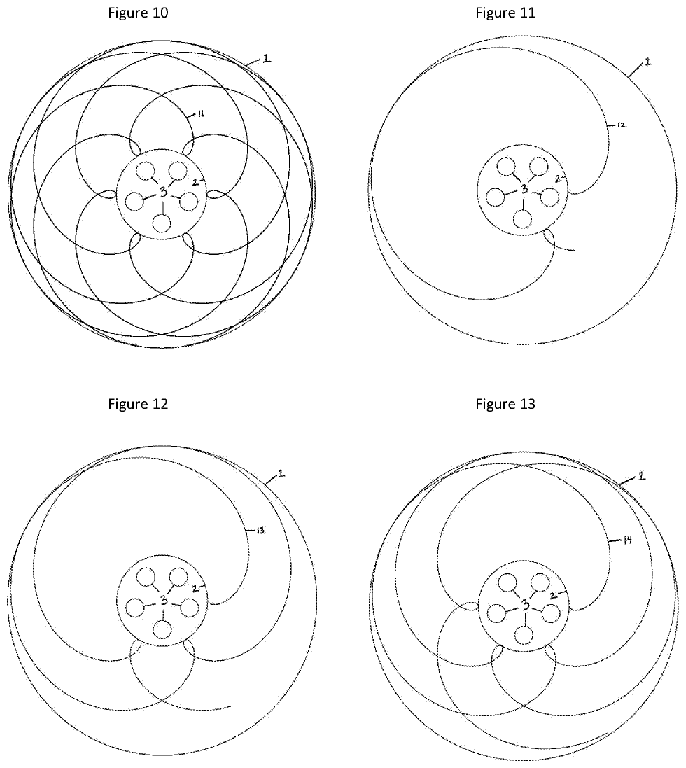

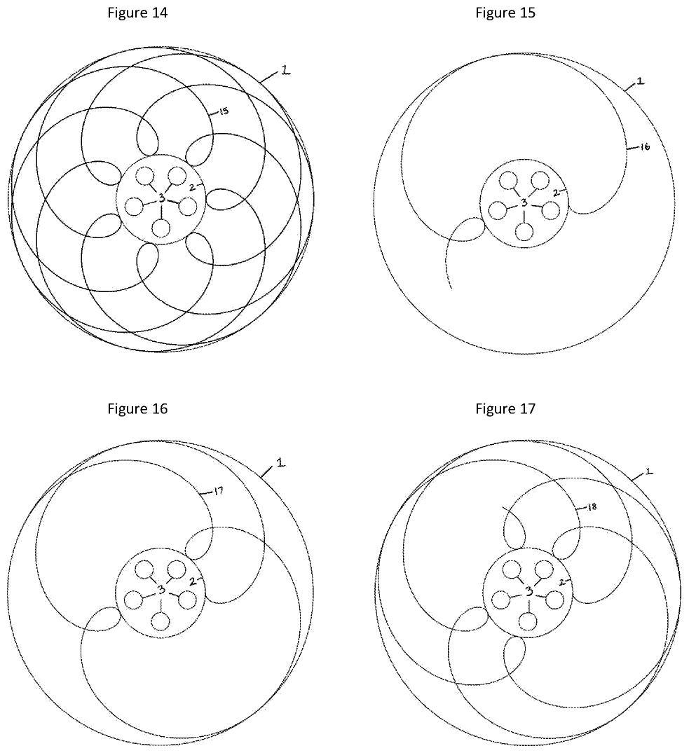

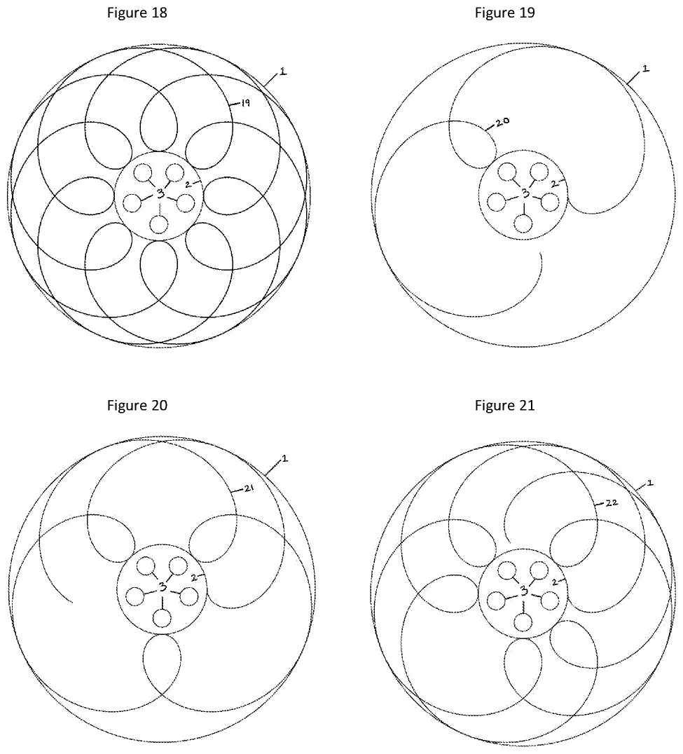

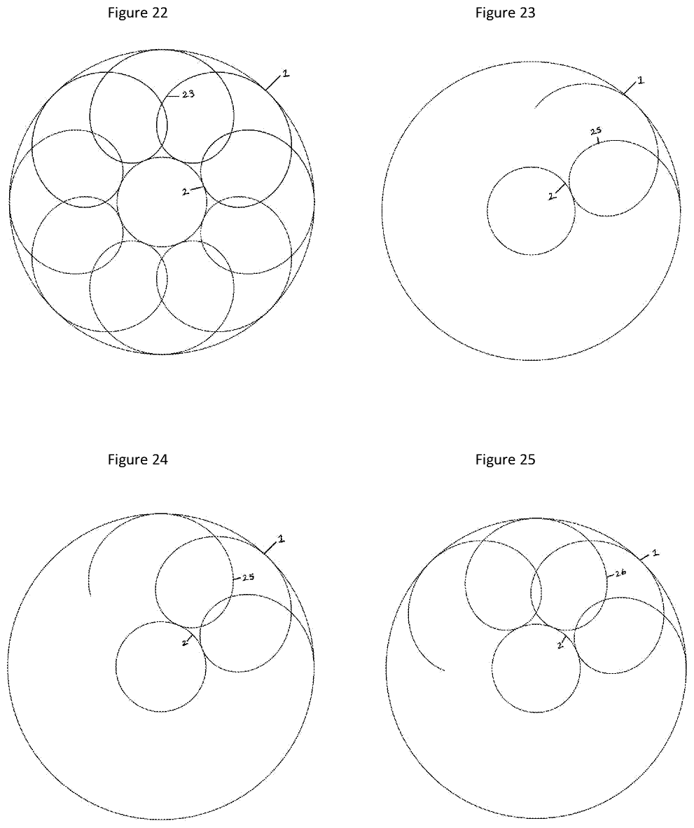

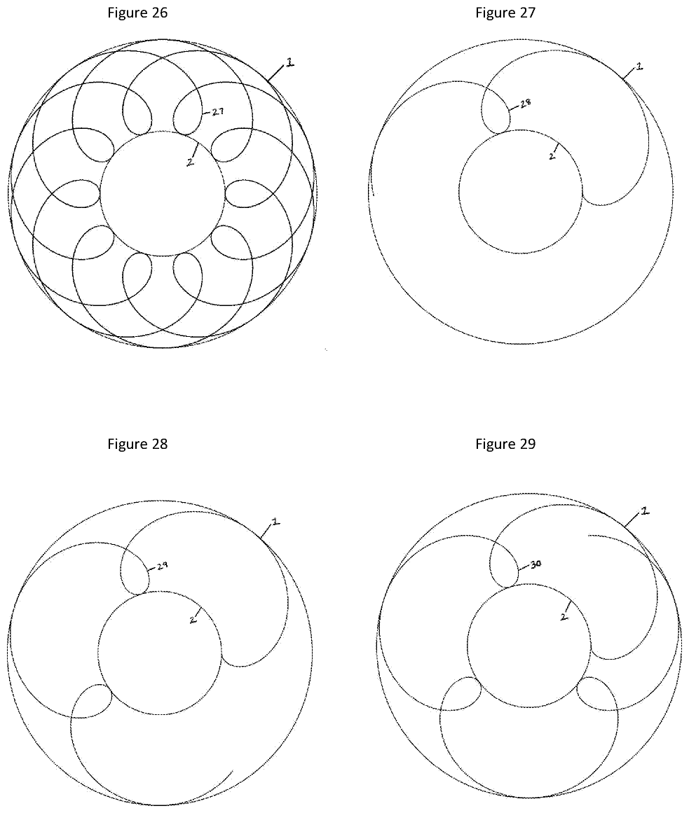

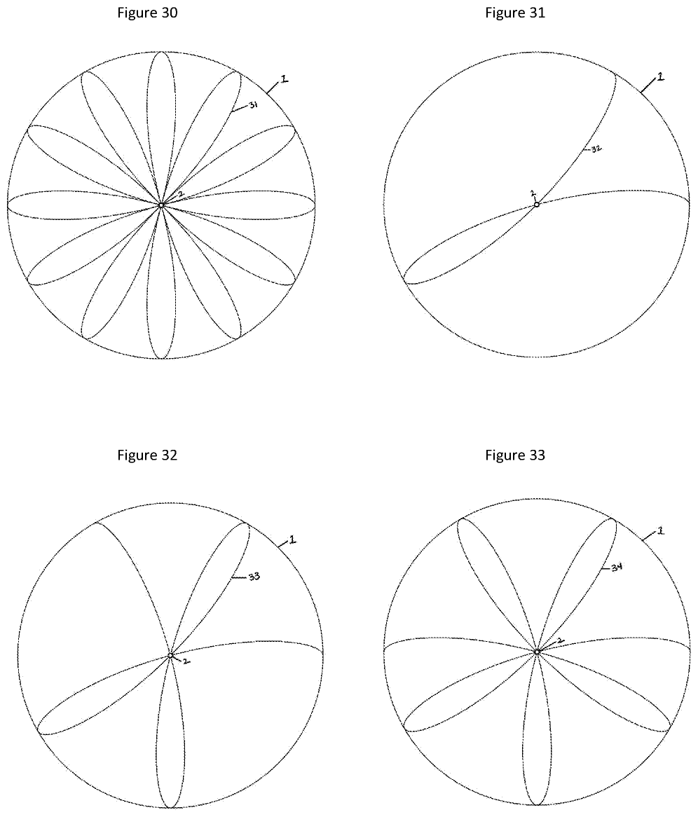

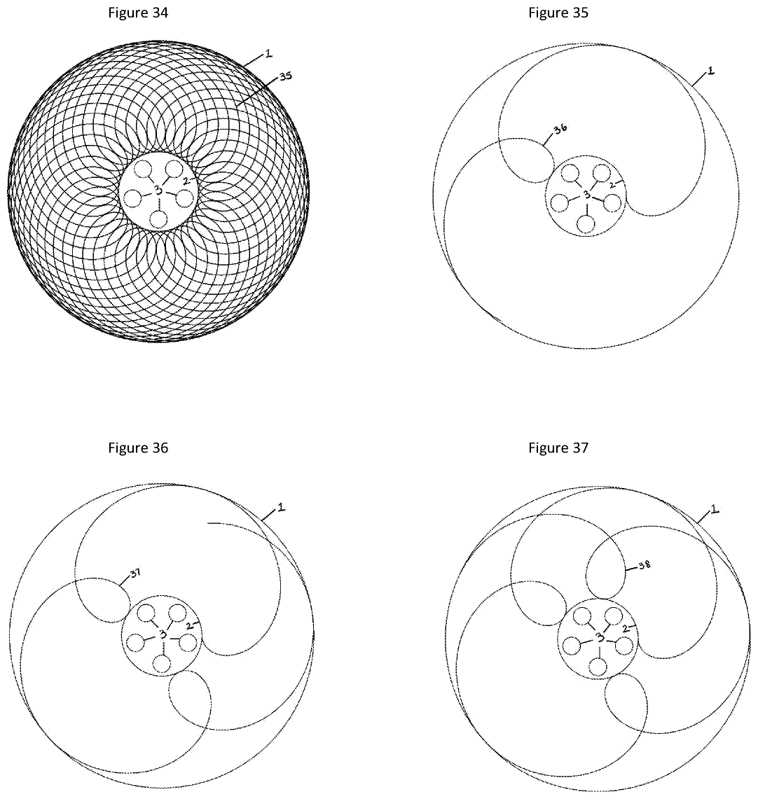

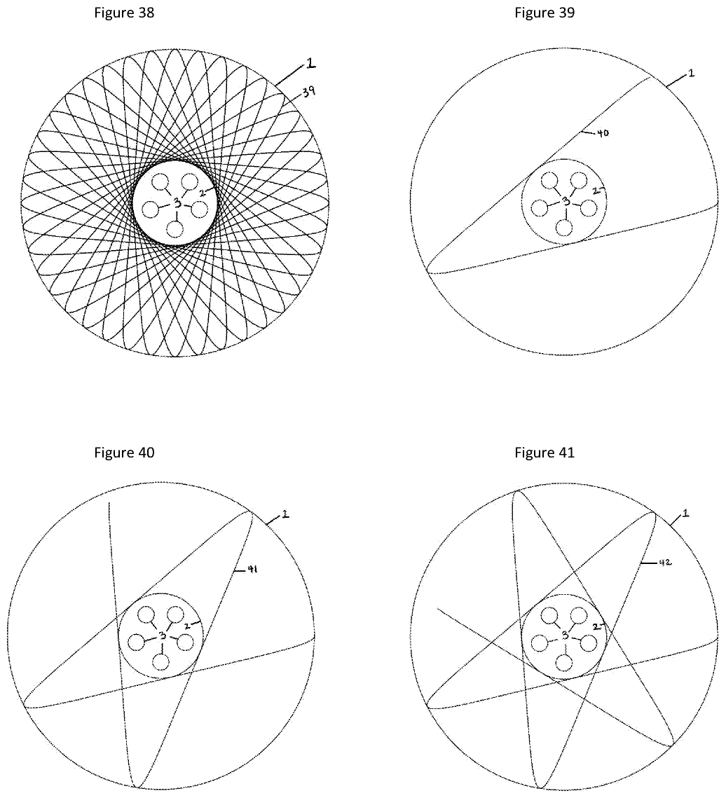

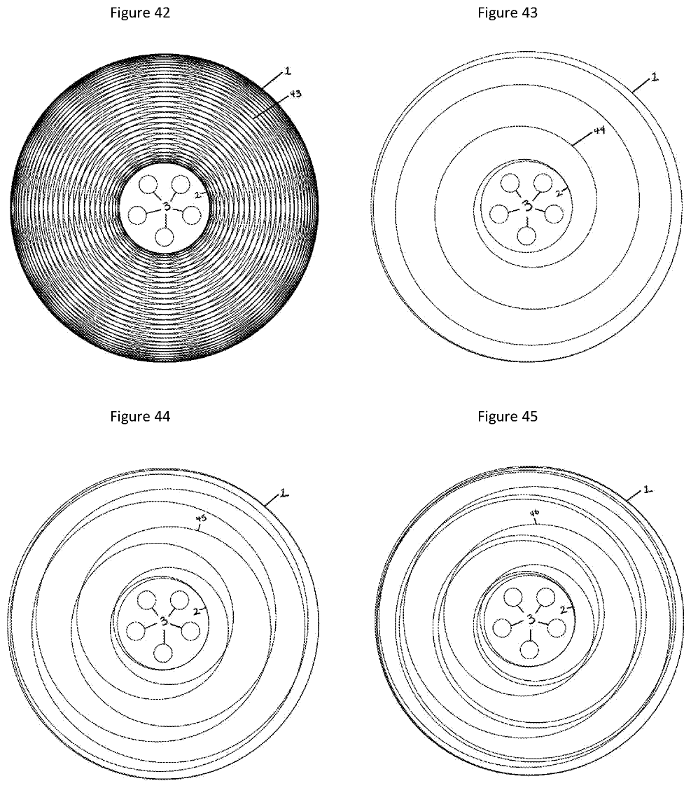

Label #46—1000 Loop Epitrochoid Spoke 1^{st} Loop across

### DETAILED DESCRIPTION OF THE INVENTION

The key to this new design in the spoke is to identify curves that are rotationally symmetrical to the origin of a circle, meet the hub and/or rim in the shape of an arc, and begin where they end. These graphs include Polar roses, hypotrochoids, epitrochoids, amongst other geometric roulettes. Polar graphs in the form r=a sin nθ and r=a cos nθ are called roses. In these equations, the value of a, controls the size. Negative values of a give the same graph as the positive values of a except they are reflected through the origin. The value of n determines the number of petals. For both equations, when n is odd n equals the number of petals, and when n is even the number of petals equals 2n, given n is a natural number. As the value of a, the amplitude in the trigonometric functions, increased, the distance between the peak and trough of the sine and cosine graphs increased, in essence creating taller waves. In a similar way, as the value of a in the roses increased, so did the length of the petals. Therefor a would be equal to the radius of the rim. The value of n in the roses is positioned in the same way as the frequency in the trigonometric graphs, the b value. Quintessentially, increasing the frequency in the trigonometric function increases the number of waves in the same interval, just like increasing the value of n in the roses increases the quantity of petals.

### Epitrochoids

$$x ( t ) = ( R + r ) cos t - p cos \frac{R + r}{r} t \\ y ( t ) = ( R + r ) sin t - p sin \frac{R + r}{r} t$$

### Hypotrochoids

$$x ( t ) = ( R - r ) cos t + p cos \frac{R - r}{r} t \\ y ( t ) = ( R - r ) sin t - p sin \frac{R - r}{r} t$$

Hypotrochoids are roulettes formed by a fixed point in a circle that rolls within a larger circle.

Epitrochaids are raulettes formed by a fixed point in a circle that rails outside a circle.

Most hypotrochoids and epitrocoids, whether in polar or parametric form, are born from the graphs of sine and cosine.

Where Cₒ is the fixed outer circle, R is the radius of the outer circle, Cᵢ is the inner circle, r is the radius of the inner circle (r<R), p is a point within the inner, and t is the independent variable. In reality

### Mathematically Speaking:

$${C}_{1} ( Circumference of the outer circle ) = 96 = 2 π r , {r}_{1} = \frac{48}{π} \\ {C}_{2} ( Circumference of the inner circle ) = 52 = 2 π r , {r}_{2} = \frac{26}{π} \\ Therefore , {r}_{1} : {r}_{2} = \frac{48}{π} : \frac{26}{π} = 48 : 26 = 96 : 52$$

The key to making roulettes with a specific number of petals is starting with circles that have rational circumferences.

When I rotate the smaller circle within the larger circle after two full rotations of the smaller circle inside the larger circle, the smaller circle clicks 104 units. If I chose a starting point on both the smaller circle and the larger circle, after two full rotations the starting point on the smaller circle will be eight units past the starting point of the outer circle. It would take 24 complete rotations of the inner circle for the two starting points to align again. To calculate the number of petals in the spiral, first I need to find the GCF of the two circles. Next, I would divide the Circumference on the outer circle by the GCF of the two circles to calculate the number of petals. If the number of units in the inner circle didn't contain a GCF greater than one with the outer circle than the number of petals would equal the number of units on the outer circle. Therefore, the maximum number of petals that can be achieved using a hypotrochoid would equal the number of units on the outer circle. More petals could be achieved when graphing on a calculator because the number of units could be irrational, but that is physically impossible. In this case, the prime factorization of 96 is 2⁵·3, so if the inner circle had a circumference (number of teeth) that was any prime number greater than three and less than 96, then there would be 96 petals on the subsequent spiral.

This summarizes the mathematical relationships between the variables in the roulettes. The user would have test different variations to find the optimum design for the user's purpose. As has been previously stated in this application, it is impossible to detail every variation in use, size, weight, speed etc. Therefor the application is for the general shape of the spoke. This shape will allow for the creation of wheels that are far superior to currently designed wheels.

1. The trochoid, polar or conic spoke can absorb and distribute forces from bumps, potholes, and other irregularities in the road more efficiently than previously designed spokes.

2. The trochoid, polar or conic spoke can use less materials for the same strength, thus making the wheel less expensive to produce and any vehicle using this spoke would require less energy to propel the vehicle and less stopping distance due to inertia than previously designed spokes.

3. A rim made with the trochoid, polar or conic spoke would take less time to manufacture, because one could make a rim with a single spoke.

4. The trochoid, polar or conic spoke creates infinitely more opportunities for creative variations in design than previously designed spokes.

5. The trochoid, polar or conic spoke creates infinitely more opportunities for uses than previously designed spokes because one could increase strength by increases the thickness of the material, and/or the number of petals in the spoke.

6. The trochoid, polar or conic spoke creates more plains of resistance than previously designed spokes, thus allowing any vehicle using it to corner or handle better than a vehicle with previously designed spokes.

7. The trochoid, polar or conic spoke utilizes the same hubs and rims as previously designed spokes and can be placed in service without modifying current rims and hubs unless the user wants to.

8. Especially in the case of the Hypotrochoid spoke, the spoke is positioned in the same direction as centripetal force instead of perpendicular to the centripetal force, thus making the transfer of energy more efficient and the strain on the spoke less.

9. The trochoid, polar or conic spoke can be made with unidirectional carbon fiber because its natural shape achieves 360 degrees of strength. The advantage being unidirectional carbon fiber is less expensive and easier to work with than multidirectional carbon fiber.

10. The trochoid, polar or conic spoke can be made with any of the modern or traditional materials, as it's the shape that's the improvement. Some materials would better take advantage of the design than others, but that would depend largely upon the use.

11. Since there are an infinite number of values that could be placed into variables for the trochoid, polar or conic spoke, such as size of wheel, speed, weight, g-forces, number of wheels, and working conditions, it is impossible to show which design is best for which purpose. Testing would have to be performed on many designs before the user would find the optimal choice for the spoke.

12. The end user of the trochoid, polar or conic spoke may choose to employ more than one trochoid, polar or conic spoke in a wheel for a myriad of reasons including but not limited to strength, safety, aesthetic etc. The benefits of the design would still be realized regardless of the number of the trochoid, polar or conic spokes used on a wheel.
